(19) United States
(12) Patent Application Publication
(10) Pub. No.: US 2025/0248798 A1
(43) Pub. Date: Aug. 7, 2025

(54) GANTRY SYSTEM FOR ANIMALS

(71) Applicant: PAW ACQUISITION I CORP., Denver, CO (US)

(72) Inventors: Glenn Parkes, Aurora, CO (US); John Barton, Aurora, CO (US)

(21) Appl. No.: 19/044,298

(22) Filed: Feb. 3, 2025

Related U.S. Application Data
(60) Provisional application No. 63/549,428, filed on Feb. 2, 2024.

(51) Int. Cl. A61D 3/00; A01K 15/04; A01K 29/00

(52) U.S. Cl. CPC A61D 3/00; A01K 29/00; A01K 15/04

(57) ABSTRACT

Embodiments of the present disclosure provide animal lifting, support and mobility systems. In some embodiments, a gantry lift and mobility system is provided that is operable to bear at least a portion of the weight of an animal and assist the animal in mobility. The devices are useful for veterinary and rehabilitation applications, but no limitation with respect to intended uses, applications, or environments is provided.

### CROSS REFERENCE TO RELATED APPLICATIONS

Pursuant to 35 U.S.C. § 119 (e), this U.S. Non-Provisional Patent application claims the benefit of U.S. Provisional Patent Application Ser. 63/549,428, entitled “GANTRY SYSTEM FOR ANIMALS,” filed on Feb. 2, 2024, and the entire disclosure of which is hereby incorporated by reference.

### FIELD

The present disclosure relates generally to animal mobility assistance devices. More specifically, embodiments of the present disclosure relate to animal lift and mobility devices for supporting at least a portion of the weight of an animal. While certain embodiments of the present disclosure are contemplated for assisting canines in veterinary settings, no limitation is provided with respect to the animal(s) to be supported or the environment(s) or application(s) in which the devices may be used.

### BACKGROUND

All animals are subject to physical ailments, whether it be due to the natural course of aging and degeneration, acute injury, illness, or other factors. Accordingly, animals often require tools and assistance to support their weight and/or to be transported around various settings. This includes, but is not limited to, veterinary care settings where animals in need of care often require support. Human healthcare providers may not be able to provide adequate support either due to the size and mass of the animal, the particular nature of the injury or ailment, or other factors.

Presently, there are only a few solutions that generally address these particular problems. Some of these solutions include ramps and chair-type devices with wheels, but known solutions provide various drawbacks.

There also exist general animal lifting solutions known that veterinarians or the like may utilize. These devices are designed to be used as a temporary lifting aid. Some known solutions include a sling connected to a handgrip, a rolled-up towel placed under the animal, or a rope. These lifting/assisting apparatuses cannot be worn by an animal through the duration of a day. These devices often present a risk of injury to the animal (and potentially the operator given the panic caused thereby) and/or do not contemplate mobility.

### SUMMARY

As such, there has been a long-felt and unmet need to provide a mobile support device for animals that is suitable for use at least in indoor settings such as veterinary clinics or hospitals, pet salons, mobile clinics, as well as outdoor settings such as barnyards, farms, ranches, fields.

Embodiments of the present disclosure provide for a lifting and transportation system for animals including, but not limited to, canines. Various embodiments comprise a gantry system that spans an open area above a floor or substrate upon which an animal can be provided. It should be recognized that various embodiments of the present disclosure contemplate supporting either a portion of a whole of an animal's weight depending on an operator's (i.e., of the mobile support device such as the gantry system) and/or an animal's particular needs. An animal may be allowed to rest a portion of its body on the substrate while the device supports or unweights a portion of the animal with an option to immobilize said portion in its position, for example, as may be useful in rehabilitation applications or medical procedures. It is further contemplated that embodiments of the present disclosure are sizeable and/or scalable, and subsequently operable to support an entire weight of an animal with the animal being fully suspended above the substrate. It is further contemplated that embodiments of the present disclosure are directed to a table- or counter-sized gantry system, for smaller animals.

Embodiments of the present disclosure contemplate various means for transmitting force to an animal to support the weight of the animal. For example, in some embodiments, an electric motor (or actuator), a winch, and a cable are provided to transmit a force to an animal and lift the animal. In alternative embodiments, a mechanical actuator (such as a manual crank arm), a winch, and a cable are provided to lift the animal. Regardless of which embodiment, the present disclosure contemplates the inclusion of a safety lock, brake, or cleat mechanism that is provided to slow, arrest, or halt and/or lock the cable in place immediately below the winch. It is contemplated that such a safety mechanism may be manually engageable or electrically engageable via a physical switch, button, or lever, and/or that such a safety mechanism may be electrically engageable via a user interface screen or may be automatically triggerable (based on real-time data relating to an animal's raised height).

Embodiments of the present disclosure contemplate various means for coupling to the animal. In various embodiments, lifts and gantry systems of the present disclosure are operable for use with harness and support devices that are provided on or otherwise in communication with an animal. For example, in some embodiments, the animal may wear a lifting harness (or other piece of apparel) to which the means for transmitting force to the animal may be coupled. For instance, the lifting harness may be a separate component that is usable with the gantry system, or a component of the gantry system itself (i.e., is provided with the gantry system). In this regard, the lifting harness may be selectively securable (and removable) from the gantry system, via a quick-release clip or carabiner, or may be integrated into the gantry system. Furthermore, the lifting harness may be secured to a lifting member, whereby force from the gantry system is distributed evenly through said lifting element(s), so as not to discomfort the animal. Additionally, at least one such lifting element is contemplated as being removably attachable to a quick-release clip such that an animal can be easily connected and disconnected from the system, which may also allow an animal to be dressed in the necessary lifting apparel and simply clip in and out of the system. In case of emergencies, it is vital that animals be able to be quickly released from the system. An additional safety mechanism contemplated for inclusion in the gantry system is a cable cleat and cleat mount, which may also be referred to herein as a brake or brake mount, whereby the winch cable may be slowed, stopped, and/or locked in place via a manual, electric, and/or automatic mechanism, such as a lever or handle, that may either disengage the winch, pin the cable against a surface with at least one polymeric brake pad, or otherwise engage the cable to slow or stop its motion.

In some embodiments, systems of the present disclosure are operable for use with and contemplated as being provided in combination with animal harness systems including but not limited to those shown and described in U.S. Pat. No. 9,320,260 to Zimmerman which is hereby incorporated by reference in its entirety and for all purposes.

Embodiments of the present disclosure are directed to the gantry system including a gantry. In some embodiments, the gantry includes a frame and a base. The frame may include a body formed from one or more members. The frame may include support plates, brackets, flanges, or the like that increase the stability and/or weight-lifting capacity of the gantry. The base may include legs that are angled to assist in reducing possible interaction between the gantry and the surrounding environment in which the gantry system is being operated, and/or may be round or elliptical. It is noted the base may additionally or alternatively include bumpers to protect the surrounding environment during movement of the gantry system, such as door jambs or other openings, furniture or fixtures, and/or the walls themselves.

In embodiments, the gantry system includes selectively securable cables that may couple to the gantry, the lifting member, and/or to the lifting harness. The cables may assist in reducing unwanted motion for the animal in the lifting harness, including front/back, side/side, up/down, or any angle therebetween in one or multiple axes of travel. The cables may also assist in maintaining an animal in an immobilized position for a period of time without causing undue stress or strain on the animal.

Embodiments of the present disclosure are directed to components that increase the mobility of the gantry system. For example, in some embodiments, the gantry system may include wheels that allow the gantry system to roll on the floor or substrate as well as lockable wheels that allow the gantry system to become partially or entirely immobilized in one location and/or position. For instance, the wheels may be on an axle to allow for monoaxial motion along a first axis, and/or include a caster body (i.e., is a caster wheel) that allows for polyaxial motion along multiple axes. In addition, the wheels may be operable for use in non-paved environments (i.e., on dirt in a barn, corral, or stable), especially where the gantry system is sized for use with animals in a barnyard and/or on a farm or ranch. Further, the wheels may be capable of replacement or interchangeability to be operable for use in otherwise inaccessible terrains, such as sandy beaches or rocky environments, wherein balloon wheels or all-terrain wheels (or other types of wheels, treads, functionally equivalent components) may be more useful. By way of another example, the gantry system may be on a rail or conveyor assembly, that allows the gantry system to actuate from between positions along a pre-defined track.

In embodiments, the gantry includes one or more handles to assist in the mobility of the gantry system. For example, the one or more handles may be individually coupled to a member of the frame assembly of the gantry (e.g., in a substantially vertical configuration). By way of another example, the one or more handles may be coupled to another member, or members, of the frame assembly (e.g., in a substantially horizontal configuration).

Embodiments of the present disclosure are directed to electric-powered components of the gantry system, that may be actuated via controls on the gantry system or via a wired or wireless remote control in communication with the gantry system. For example, in some embodiments, the aforementioned means for transmitting force may be actuated via electronic controls installed on the gantry system or on a remote control in communication with the gantry system. By way of another example, in some embodiments, the aforementioned wheels of the gantry system may be powered via an electric motor (or other actuator) that may be actuated via electronic controls installed on the gantry system or on a remote control in communication with the gantry system.

Embodiments of the present disclosure are directed to the gantry system including one or more computers (i.e., control panel, controller, control system, control unit, or the like) including processors and memory configured to store program instructions executable by the processors. It is noted that the gantry system may include one or multiple computers that are standalone systems, individual systems in communication with one another, related sub-systems within a primary system, or the like.

In embodiments, the computer may include interfaces with displays, input devices (i.e., visual/aural/tactile input devices), and/or output devices (i.e., visual/aural/tactile output devices). For example, the interfaces may be installed within the components of the gantry system and/or within the handles of the gantry system. By way of another example, the interfaces may be in wired or wireless communication with electrical components (e.g., plugs, ports, transmitters, receivers, transceivers, or the like) of the gantry system.

In embodiments, the gantry system may include onboard power sources including batteries, battery packs, or the like. It is contemplated that including onboard power sources increases the mobility of the gantry system, as the gantry system is not physically tied to a particular location via a wired connection. However, in other embodiments the gantry system includes a power cable that is either fully extended from the gantry system and/or is retractably extendable (i.e., can retract, be wrapped up, or the like) from the gantry system.

In embodiments, the gantry system may include (or be in communication with) sensors that are operable to acquire data about the animal, about the gantry system, and/or about the operator. For example, in some embodiments, the sensors may monitor vital signs of the animal. By way of another example, in some embodiments, the sensors may monitor the gantry system and the environment in which the gantry system is being operated. By way of another example, in some embodiments, the sensors may monitor the proximity of an operator relative to the gantry system (i.e., to ensure that the animal being at least partially supported by the gantry system is not left unattended beyond a select period of time). The sensors may be in communication with the computer.

In embodiments, the gantry system includes lighting. For example, the lighting may be usable during examination of the animal. By way of another example, the lighting may be usable to keep the animal in a particular environment. For example, the lighting may provide a calming, warming, or other beneficial effect to the animal while being supported by the gantry system. It is contemplated that the gantry system may include additional visual stimuli, and/or aural stimuli and/or tactile stimuli that provide a beneficial effect to the animal while being supported by the gantry system.

In some non-limiting embodiments, the gantry system may be sized for use in water therapy. For example, a water basin or tub may fit within the boundaries of the gantry system (i.e., between legs of the base—its basal members—or between its support members). By way of another example, the gantry system may be movable to be positioned above a water basin and the system may allow for the lowering of the animal below the gantry system's frame assembly into the water basin. It is noted that the gantry system may be partially or completely water-proofed (i.e., via choice of material, coatings, mechanical element shielding, electronic shielding, or the like) to prevent wear-and-tear or other damage to the gantry system.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about.”

The use of “substantially” in the present disclosure, when referring to a measurable quantity (e.g., a diameter or other distance) and used for purposes of comparison, is intended to mean within 5% of the comparative quantity. The terms “substantially similar to,” “substantially the same as,” and “substantially equal to,” as used herein, should be interpreted as if explicitly reciting and encompassing the special case in which the items of comparison are “similar to,” “the same as” and “equal to,” respectively.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. The use of “engaged with” and variations thereof herein is meant to encompass any direct or indirect connections between components.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary, brief description of the drawings, detailed description, abstract, and claims themselves.

All external references are hereby incorporated by reference in their entirety whether explicitly stated or not.

These and other advantages will be apparent from the disclosure contained herein. The above-described embodiments, objectives, and configurations are neither complete nor exhaustive. The Summary is neither intended nor should it be construed as being representative of the full extent and scope of the present disclosure. Moreover, references made herein to “the present disclosure,” or aspects thereof should be understood to mean certain embodiments of the present disclosure and should not necessarily be construed as limiting all embodiments to a particular description. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

It is to be appreciated that any embodiment, feature, or aspect described herein can be claimed in combination with any other embodiment(s), feature(s), or aspect(s) as described herein, regardless of whether the features or aspects come from the same described embodiment. For example, any one or more aspects described herein can be combined with any other one or more aspects described herein. In addition, any one or more features described herein can be combined with any other one or more features described herein. Further, any one or more embodiments described herein can be combined with any other one or more embodiments described herein.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In addition, the materials, methods, and examples are illustrative only and are not intended to be necessarily limiting.

### DESCRIPTION OF THE DRAWINGS

FIG. 1 is a perspective view of a gantry lift device according to one embodiment of the present disclosure.

FIG. 2 is a front elevation view of the device of the embodiment of FIG. 1.

FIG. 3 is a front elevation view of the device of the embodiment of FIG. 1.

FIG. 4 is an exploded perspective view of the device of the embodiment of FIG. 1, including circled areas.

FIG. 5 is a detailed perspective view of a circled area of FIG. 4.

FIG. 6 is a detailed perspective view of a circled area of FIG. 4.

FIG. 7 is a detailed perspective view of a circled area of FIG. 4.

FIG. 8 is a detailed perspective view of a circled area of FIG. 4.

FIG. 9 is a detailed perspective view of a circled area of FIG. 4.

FIG. 10 is a detailed perspective view of a circled area of FIG. 4.

FIG. 11 is a perspective view of a gantry lift device, according to embodiments of the present disclosure.

FIG. 12 is an exploded perspective view of the gantry lift device of FIG. 11, including circled areas.

FIG. 13 is a detailed perspective view of a circled area of FIG. 12.

FIG. 14 is a detailed perspective view of a circled area of FIG. 12.

FIG. 15 is a perspective view of a winch assembly, according to embodiments of the present disclosure.

FIG. 16 is a side elevation view of a lift member for use with the winch assembly of FIG. 15.

It should be understood that the drawings are not necessarily to scale, and various dimensions may be altered. In certain instances, details that are not necessary for an understanding of the disclosure or that render other details difficult to perceive may have been omitted. It should be understood, of course, that the disclosure is not necessarily limited to the particular embodiments illustrated herein.

| Reference Number | Component |
|---|---|
| 1 | Gantry Assembly |
| 2 | Winch Assembly |
| 3 | Battery Port |
| 4 | Handle |
| 5 | Panel |
| 6 | Panel |
| 7 | Cable Bracket |
| 8 | Control Panel Assembly |
| 9 | Power Switch |
| 10 | Actuator Switch Bracket |
| 11 | Battery Cable Bracket |
| 12 | Actuator Switch |
| 13 | Vibration Dampener |
| 14 | Fastener |
| 15 | Fastener |
| 16 | Battery |
| 17 | Fastener |
| 18 | Electronics Bracket |
| 19 | Power Cable |
| 20 | Plug |
| 21 | Frame |
| 22 | Body |
| 23 | Support Member |
| 24 | Support Member |
| 25 | Crossmember |
| 26 | Crossmember |
| 27 | Base Assembly |
| 28 | Basal Member |
| 29 | Wheel |
| 30 | Gusset |
| 31 | Plate |
| 32 | Winch Mount |
| 33 | Bar |
| 34 | Fastener |
| 35 | Fastener |
| 36 | Winch Aperture |
| 37 | Winch Bracket |
| 38 | Actuator |
| 39 | Insulator |
| 40 | Fastener |
| 41 | Fastener |
| 42 | Cleat Mount |
| 43 | Cleat |
| 44 | Handle |
| 45 | Fastener |
| 46 | Electrical Connector |
| 48 | Cable |
| 49 | Lifting Member |
| 50 | Clip |
| 51 | Lifting Harness |
| 100 | Gantry System |
| 101 | Control System |

### DETAILED DESCRIPTION

It is to be understood that the disclosure is not limited to particular methods or systems, which can, of course, vary. It is also to be understood that the terminology used herein is for the purpose of describing particular embodiments only and is not intended to be limiting. Although the following text sets forth a detailed description of numerous different embodiments, it should be understood that the legal scope of the description is defined by the words of the claims set forth at the end of this disclosure. The Detailed Description is to be construed as exemplary only and does not describe every possible embodiment since describing every possible embodiment of the gantry system would be impractical, if not impossible. Numerous alternative embodiments could be implemented, using either current technology or technology developed after the filing date of this patent, which would still fall within the scope of the claims. Additionally, any combination of features shown in the various figures can be used to create additional embodiments of the present disclosure. Thus, dimensions, aspects, and features of one embodiment of the gantry system can be combined with dimensions, aspects, and features of another embodiment of the gantry system to create the claimed embodiment.

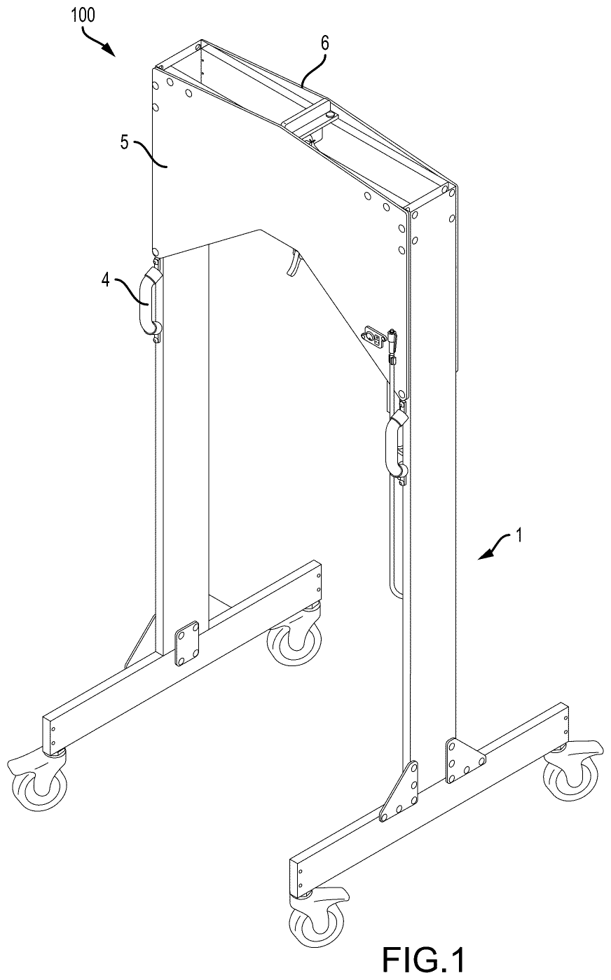

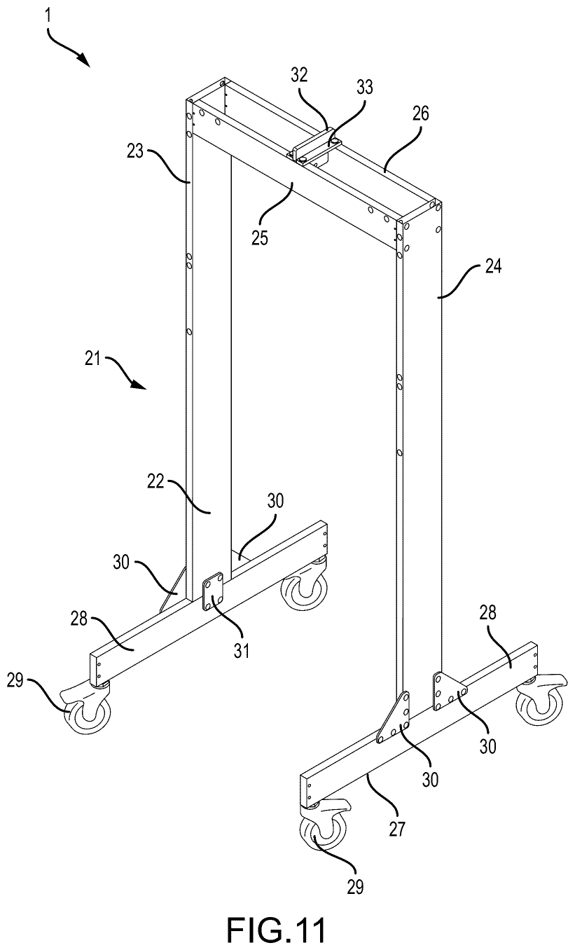

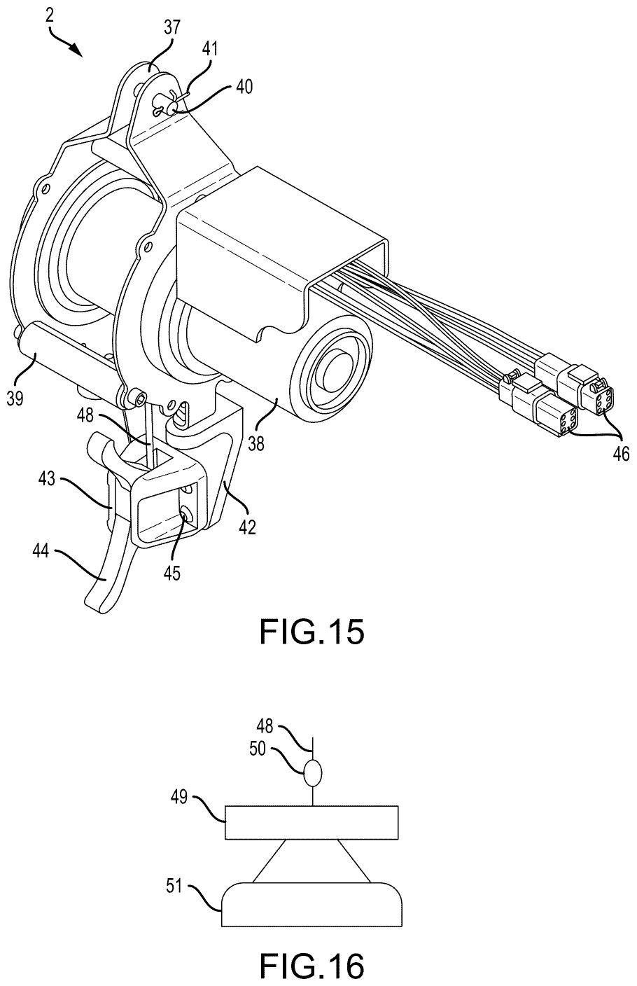

FIGS. 1-10 in general illustrate a gantry system 100, in accordance with one or more embodiments of the present disclosure. The gantry system 100 includes a gantry assembly 1 (which may be considered equivalent with “gantry,” for purposes of the present disclosure) and a winch assembly 2. It is noted that the gantry assembly 1 is described in detail with respect to FIGS. 11-14 further herein. In addition, it is noted that the winch assembly 2 is described in detail with respect to FIGS. 15 and 16 further herein.

As illustrated in FIG. 1, the gantry system 100 includes the gantry assembly 1. In embodiments, one or more handles 4 are coupled to the gantry assembly 1. For example, the one or more handles 4 assist in moving the gantry system 100. The one or more handles 4 may be individually coupled to the gantry assembly 1 along one side/end in a substantially vertical orientation. It is contemplated, however, that the one or more handles 4 may be coupled to the gantry assembly 1 in a substantially horizontal orientation, either along one side (similar to the illustrated vertically oriented handle 4), across one end (i.e., similar to a cart handle or handlebar), or spanning multiple sides and/or ends. It is further contemplated that one or more handles 4 may be oriented at an angle between said substantially vertical and substantially horizontal orientations, or may be capable of angle orientation alteration without necessitating the removal and reattachment of said handle 4.

It is contemplated that the handle 4 may be any known handle shape, without departing from the scope of the present disclosure. In addition, it is contemplated that the handle 4 may be unpatterned or patterned (i.e., with a gripping surface), and/or unwrapped or wrapped (i.e., with a foam or rubber grip), without departing from the scope of the present disclosure.

The gantry system 1 includes panels 5, 6 across one or more sides. For example, the panel 5 may span at least a portion of a first side between the outer ends of the gantry assembly 1, while the panel 6 may span at least a portion of a second side between the outer ends of the gantry assembly 1. As generally illustrated in FIGS. 1-8, the panels 5, 6 may protect internal components housed within a cavity defined by the gantry assembly 1, and/or may provide additional support to the gantry assembly 1 to increase the weight-lifting capacity of the gantry system 100.

It is contemplated that the panels 5, 6 may be configured to hold documents, medical devices, and/or other items useful in the medical profession while the gantry system 100 is in use. For example, the panels 5, 6 may be magnetic, to hold papers (i.e., related to the animal, to treatments, or the like) with magnets against the panels 5, 6. By way of another example, the panels 5, 6 may include folders, shelves, brackets, interlocking assembly components (i.e., protrusions, recesses, etc.) fasteners, or the like, which are able to hold documents and/or medical treatment devices on the gantry assembly 1.

In general, it should be understood that panels 5, 6 and the components installed thereon may be interchangeable with respect to a particular side of the gantry system 100, as the animal being supported by the gantry assembly 1 may face toward either side of the gantry system 100, without departing from the scope of the present disclosure. In addition, although the one or more handles 4 are illustrated as being coupled directly to the gantry assembly 1, it is contemplated that the handles 4 may be coupled to (or integrally formed with) the panels 5, 6, without departing from the scope of the present disclosure.

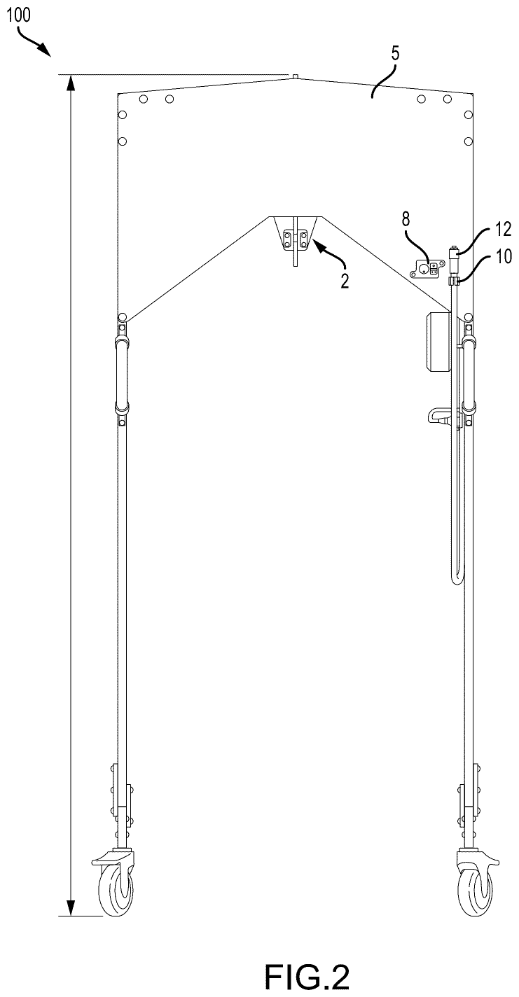

Referring now to FIG. 2, at least a portion of the winch assembly 2 is visible and/or accessible relative to the panel 5 (and/or panel 6, although not shown in FIG. 2). This is beneficial where the winch assembly 2 includes a manual locking mechanism that must be accessed by an operator, as described in detail further herein. It is contemplated, however, that the locking mechanism may be electronic, or may not be included on the winch assembly 2, and that no portion of the winch assembly 2 needs to be visible and/or accessible relative to the panels 5, 6, without departing from the scope of the present disclosure.

In some embodiments, the panel 5 (or panel 6, although not shown) includes a control panel assembly 8. In some embodiments, the control panel assembly 8 is held by an operator, and is coupled to the gantry assembly 1 via direct or indirect, wired or wireless, communication. In other embodiments, the control panel assembly 8 includes a plate with one or more toggles or buttons that are directly installed on the gantry assembly 1, including within an aperture in (or directly on a surface of) a panel 5 (or 6).

In embodiments, the panel 5 (or panel 6, although not shown), includes an actuator switch bracket 10 operable to receive and retain an actuator switch 12. The actuator switch 12 may be usable to control the winch assembly 2, including raising or lowering the height of the animal within the gantry system 100 while the animal is being supported, to increase or reduce the support provided to the animal. In some embodiments, the actuator switch 12 in a trigger-like toggle device that is held by an operator, and is coupled to the winch assembly 2 via direct or indirect, wired or wireless, communication. In other embodiments, the actuator switch 12 is one or more toggles or buttons that are directly installed on the gantry assembly 1, including within an aperture in (or directly on a surface of) a panel 5 (or 6).

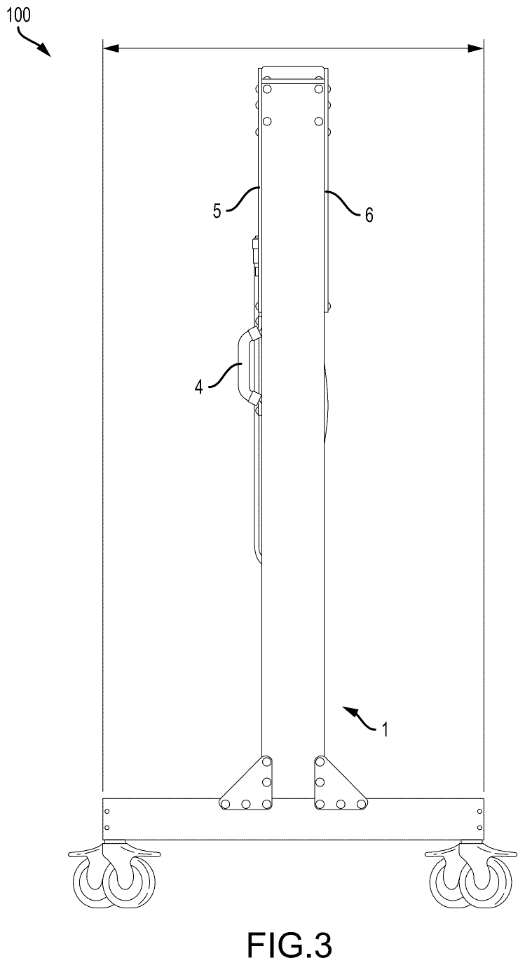

Referring now to FIGS. 2 and 3, in some embodiments the handles 4 may be positioned on the same side of the gantry assembly 1 as the panel 5 (or 6) that includes the control panel assembly 8 and/or the actuator switch 12. Positioning all control features of the gantry system 100 (i.e., both electronic and manual features) in a more consolidated area on the gantry system 100 allows for an increased ease of access by an operator. However, it should be understood that the locations of the handles 4, the control panel assembly 8, and/or the actuator switch 12 are not dependent on one another, without departing from the scope of the present disclosure.

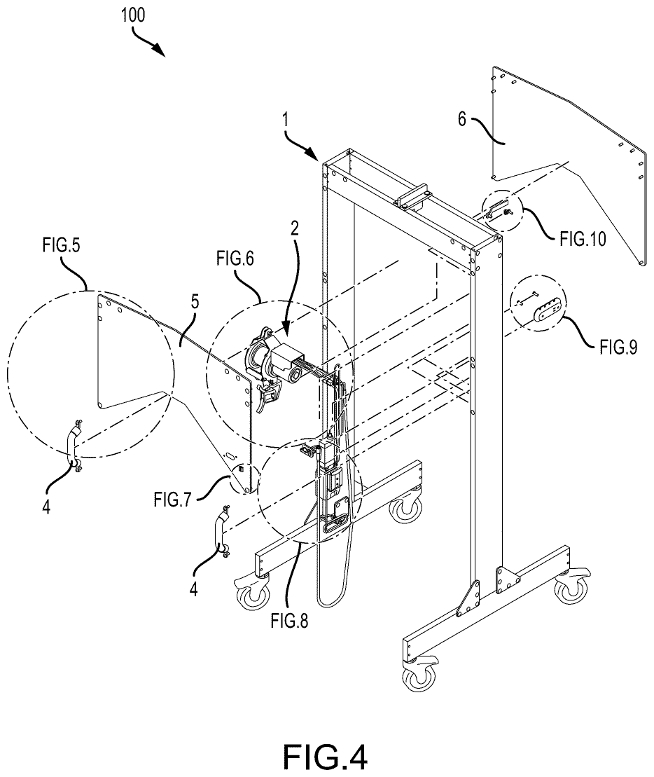

Referring now to FIG. 4, the gantry system 100 is illustrated in an exploded perspective view. References lines are shown to illustrate exemplary positioning and direction of installation of the various components of the gantry system 100 (as described into detail throughout this disclosure) onto the gantry assembly 1, including the winch assembly 2, the handles 4, the panel 5, the panel 6, and other components coupled to the gantry assembly 1 as described in detail herein. The detailed areas of the gantry system 100, as illustrated in FIG. 4 with dot-dash line circles, are described in detail further herein.

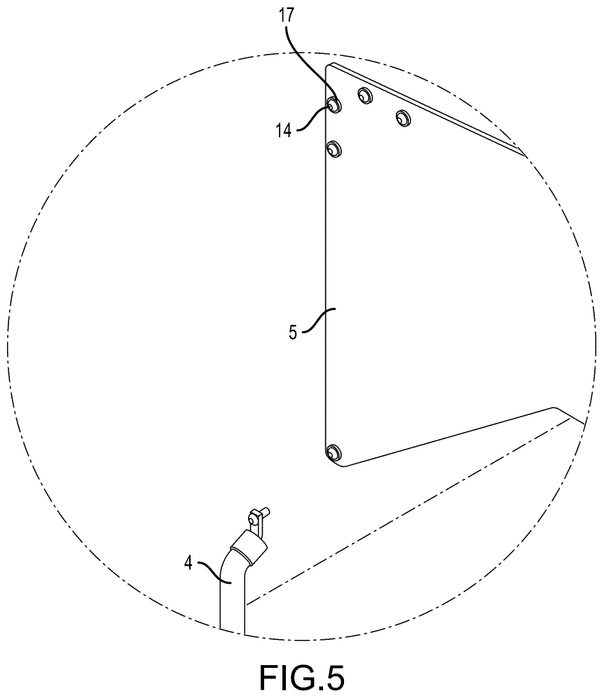

Referring now to FIG. 5, a detailed area illustrates a portion of a handle 4 and the panel 5 (or panel 6, depending on the configuration of the gantry system 100). The panel 5 is configured to receive fasteners 14, 17 (i.e., within apertures or grooves in the panel 5), where the fasteners 14, 17 secure the panel 5 to the gantry assembly 1 (not shown). For example, the fasteners 17 may include a washer and the fasteners 14 may include a bolt, screw, or other component that threads (or otherwise interlocks) with a corresponding feature on (or proximate to) the gantry assembly 1. For instance, the gantry assembly 1 may include a corresponding aperture that is threaded, and/or an aperture that leads to a nut (i.e., either positionable proximate to, or affixed to, the gantry assembly 1). In general, the panel 5 may include a first component of an interlocking assembly that engages a second component of the interlocking assembly on (or in) the gantry assembly 1. It is contemplated that the interlocking assembly may be quick-release or configured like a tab-and-groove assembly, to allow for increased ease of removal of the panel 5 from the gantry assembly 1 and access to components projected by the panel 5.

Although not shown, it should be understood that panel 6 may be configured to separately secure to the gantry assembly 1 in a similar manner as described above with respect to panel 5. However, in some embodiments, such as where the fasteners 14 extend through the panel 5 and the gantry assembly 1, it is contemplated that the panel 6 may also receive the fasteners 14 (i.e., prior to the installation of a nut on the end of the fasteners 14).

The handle 4 is similarly configured to receive fasteners that secure the handle 4 to the gantry assembly 1 or, in general, may include a first component of an interlocking assembly that engages a second component of the interlocking assembly on (or in) the gantry assembly 1. It is contemplated that the interlocking assembly may be quick-release or configured similar to a tab-and-groove assembly, to allow for increased ease of removal of the handle 4 from the gantry assembly 1. It is contemplated that further embodiments of the handle 4 may include pull and rotate capabilities, wherein a handle 4 may be rotated into a different angle of use then pushed in to relock it into place, or may include tracks along which a handle may be raised/lowered without requiring removal and reattachment.

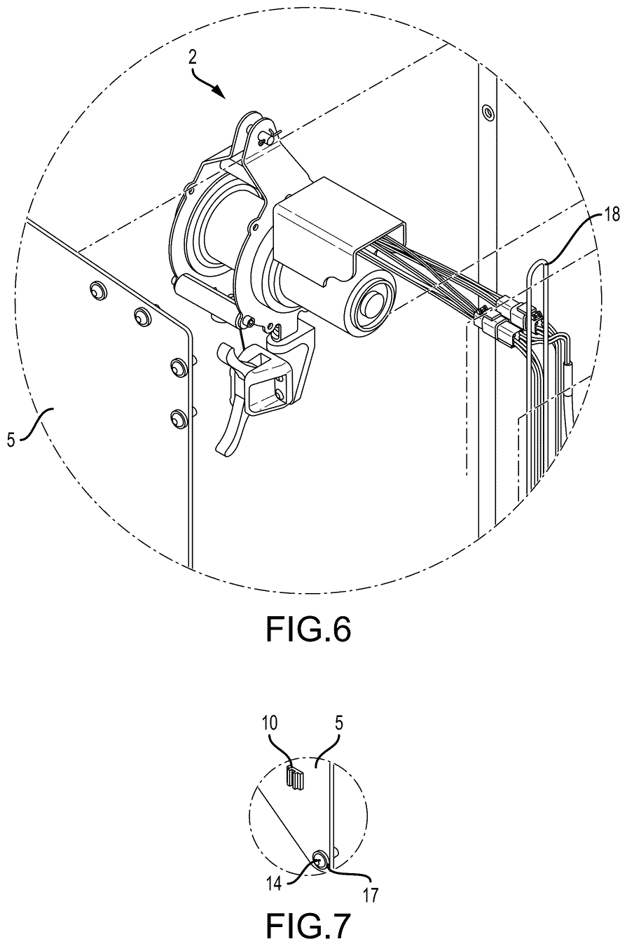

Referring now to FIG. 6, a detailed area illustrates the winch assembly 2. The winch assembly 2 is generally positioned behind the panel 5 and within a cavity defined by the gantry assembly 1. Additional aspects of the winch assembly 2 are illustrated in FIG. 15 and described in detail further herein.

In embodiments where the winch assembly 2 is wired, the gantry system 100 may include an electronics bracket 18, to which various components illustrated in FIGS. 4 and 8-10 may be coupled and/or otherwise in communication. It is contemplated that the gantry assembly 1, however, may include apertures or grooves within members through which the electronics may be positioned (or electric cables may be routed), so that the electronics (or electric cables) are not readily accessible exterior to the members of the gantry assembly 1.

Referring now to FIG. 7, a detailed area illustrates another section of panel 5 (or panel 6). In the embodiments where the actuator switch 12 is handheld, the actuator switch bracket 10 may be positioned on the panel 5, to which the operator may couple the actuator switch 12 (i.e., when not in use). The panel 5 is configured to receive fasteners 14, 17 (i.e., within apertures or grooves in the panel 5), where the fasteners 14, 17 secure the panel 5 to the gantry assembly 1 (not shown). For example, the fasteners 17 may include a washer and the fasteners 14 may include a bolt, screw, or other component that threads (or otherwise interlocks) with a corresponding feature on (or proximate to) the gantry assembly 1. For instance, the gantry assembly 1 may include a corresponding aperture that is threaded, and/or an aperture that leads to a nut (i.e., either positionable proximate to, or affixed to, the gantry assembly 1). In general, the panel 5 may include a first component of an interlocking assembly that engages a second component of the interlocking assembly on (or in) the gantry assembly 1. It is contemplated that the interlocking assembly may be quick-release or configured like a tab-and-groove assembly, to allow for increased ease of removal of the panel 5 from the gantry assembly 1 and access to components projected by the panel 5.

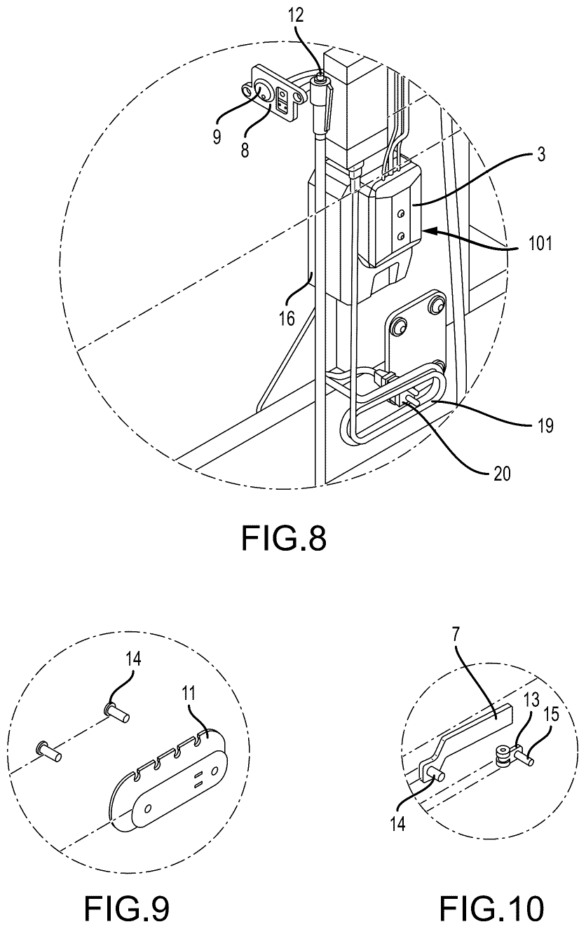

Referring now to FIG. 8, a detailed area illustrates a battery assembly 3 with a battery 16. In embodiments, the control panel assembly 8 with power switch 9 and the actuator switch 12 are each in communication the battery assembly 3. In some embodiments, the power switch 9 is a multi-toggle switch, where a first position of the toggle switch causes the actuator switch 12 to drive the winch assembly 2 in a first direction (i.e., is a first “on” position), a second position of the toggle switch causes the actuator switch 12 to drive the winch assembly 2 in a second direction (i.e., is a second “on” position), and a third position of the toggle switch causes power to be interrupted to the winch assembly 2 (i.e., is an “off” position). It is contemplated, however, that the actuator switch may have the circuitry to drive the winch assembly 2 in different directions, such that the power switch 9 only includes a single “on” position and the “off” position, without departing from the scope of the present disclosure.

As illustrated in FIG. 8, a control system 101 may be in communication with the battery port 3. The control system 101 may power input and/or power output of the battery 16, and/or power input and/or power output of the winch assembly 2 (not shown). The control system 101 may be coupled to the battery 16 and/or the winch assembly 2 via wired connections and/or via wireless connections.

In general, the control system 101 may include one or more control units (e.g., a controller, server, or the like). The one or more control units may include processors and memory (e.g., a memory medium, memory device, or the like). The processors may be configured to execute program instructions maintained on or stored in the memory. The processor of the one or more control units may execute any of the various method or process steps necessary to operate the gantry system 100, and/or the subassemblies and/or components of the gantry system 100.

The control system 101 may include a user interface coupled (e.g., physically coupled, electrically coupled, communicatively coupled, or the like) to the one or more control units. For example, the user interface may be a separate device coupled to the one or more control units. By way of another example, the user interface and the one or more control units may be located within a common or shared housing. The user interface may include one or more displays, one or more user input devices, and/or one or more port connectors (e.g., for the transmitting and/or receiving of power and/or data, and the like).

The control system 101 may include one or more sensors coupled (e.g., physically coupled, electrically coupled, communicatively coupled, or the like) to or integrated in the one or more control units, the gantry system 100, and/or the subassemblies and/or components of the gantry system 100. The one or more sensors may be operable to determine various operational, physical, and/or environmental parameters of the gantry system 100, the subassemblies and/or components of the gantry system 100, and/or the control system 101; the environment surrounding the gantry system 100, the subassemblies and/or components of the gantry system 100, and/or the control system 101, and the like. For instance, the sensors may be operable to determine the power input and/or power output of the gantry system 100, the subassemblies and/or components of the gantry system 100 including the battery 16 and the winch assembly 2, and/or the control system 101.

The control system 101 may include one or more transmitters and/or receivers coupled (e.g., physically coupled, electrically coupled, communicatively coupled, or the like) to or integrated in the one or more control units, the gantry system 100, and/or the subassemblies and/or components of the gantry system 100. The one or more transmitters and/or receivers may be configured to transmit data to and/or receive data from the gantry system 100 and/or the subassemblies and/or components of the gantry system 100 (e.g., from sensors installed within the gantry system 100 and/or the subassemblies and/or components of the gantry system 100) or from external third-party control units (e.g., controllers, servers, or the like) either via wired connections or wireless connections, which may be configured as transmitting (Tx) units, receiving (Rx) units, or combination Tx/Rx units.

The control system 101 may be configured to monitor the gantry system 100 and/or the subassemblies and/or components of the gantry system 100 via received and/or transmitted data. The control system 101 may be configured to generate control signals to adjust one or more components of the gantry system 100 and/or the subassemblies and/or components of the gantry system 100 via a feedback loop or a feed forward loop based on the received and/or transmitted data. The control system 101 may be configured to receive and/or transmit data in a standardized format and/or a non-standardized format. Where the data is in a non-standardized format, the data may be converted to a standardized format upon receipt and/or prior to transmission to sensors, third-party control units, or the like.

Referring now to FIG. 9, a detailed area illustrates a battery cable bracket 11 installable on the gantry assembly 1. In embodiments, the battery 3 is not removable from the battery port 16, and is rechargeable via a power cable 19 and plug 20 in communication with the battery port 16. To consolidate components, the gantry system 100 may include the battery cable bracket 11 that is configured to receive the power cable 19, and optionally the plug 20. For example, the power cable 19 may wrap around the battery cable bracket 11, and the battery cable bracket 11 may optionally include apertures into which the plug 20 may be inserted. Alternatively, the plug 20 may clip directly to the power cable 19.

It is contemplated, however, that the battery 16 may be removable from the battery port 3, and chargeable with a separate battery charger that is plugged into a wall socket, either in addition to or instead of charging the battery 16 via the battery port 3 with the power cable 19, without departing from the scope of the present disclosure.

In addition, it is contemplated that the gantry system 100 may be hard-wired, such that power is applied to the winch assembly 2 (and switches 9, 12) when the power cable 19 is plugged into a wall socket. It is noted that this hard-wiring may be in addition to or instead of the battery 16, without departing from the scope of the present disclosure.

Referring now to FIG. 10, a detailed area illustrates a cable bracket 7 that is installable on the gantry assembly 1. The cable bracket 7 is usable to prevent the cables in communication with the winch assembly 2 from dismounting from the gantry assembly 1, thus keeping the cables in place against the gantry assembly 1. The cable bracket 7 is configured to receive fasteners 14, 17 (i.e., within apertures or grooves in the cable bracket 7), where the fasteners 14, 17 secure the cable bracket 7 to the gantry assembly 1 (not shown). For example, the fasteners 17 may include a washer and the fasteners 14 may include a bolt, screw, or other component that threads (or otherwise interlocks) with a corresponding feature on (or proximate to) the gantry assembly 1. For instance, the gantry assembly 1 may include a corresponding aperture that is threaded, and/or an aperture that leads to a nut (i.e., either positionable proximate to, or affixed to, the gantry assembly 1). In general, the cable bracket 7 may include a first component of an interlocking assembly that engages a second component of the interlocking assembly on (or in) the gantry assembly 1. It is contemplated that the interlocking assembly may be quick-release or configured like a tab-and-groove assembly, to allow for increased ease of removal of the cable bracket 7 from the gantry assembly 1.

In embodiments, the gantry system 100 includes a vibration dampener 13 that reduces vibration transferred between the winch assembly 2 and the gantry assembly 1. The vibration dampener 13 is configured to receive fasteners 15 (i.e., within apertures or grooves in the vibration dampener 13), where the fasteners 15 secure the vibration dampener 13 to the gantry assembly 1 (not shown). For example, the fasteners 15 may include a bolt, screw, or other component that threads (or otherwise interlocks) with a corresponding feature on (or proximate to) the gantry assembly 1. For instance, the gantry assembly 1 may include a corresponding aperture that is threaded, and/or an aperture that leads to a nut (i.e., either positionable proximate to, or affixed to, the gantry assembly 1). In general, the vibration dampener 13 may include a first component of an interlocking assembly that engages a second component of the interlocking assembly on (or in) the gantry assembly 1. It is contemplated that the interlocking assembly may be quick-release or configured like a tab-and-groove assembly, to allow for increased ease of removal of the vibration dampener 13 from the gantry assembly 1.

Although embodiments are directed to the winch assembly 2 being driven via electronics, it should be understood that the winch assembly 2 may be manually-driven by the operator, without departing from the scope of the present disclosure. For example, the gantry system 100 may include a crank, cable, and series of one or more pulleys to drive the winch assembly when raising or lowering the animal to increase or decrease support of the animal.

FIGS. 11-14 in general illustrate the gantry assembly 1, in accordance with one or more embodiments of the present disclosure. It should be understood that embodiments directed to the gantry assembly 1 as illustrated in FIGS. 1-10 are directed to the embodiments of the gantry assembly 1 as illustrated in FIGS. 11-14, and vice versa, without departing from the scope of the present disclosure.

Referring now to FIG. 11, the gantry assembly 1 includes a frame 21. For example, the handles 4, the panels 5, 6, and the winch assembly 2 with accompanying electronic components may be coupled to the frame 21. The frame 21 defines a cavity, in which the winch assembly 2 and the various electronic components may be installed to the gantry assembly 1.

In embodiments, the frame 21 includes a body 22 formed of one or more members. In some embodiments, the body 22 includes one or more support members and one or more crossmembers. In one non-limiting example, the body 22 includes a first support member 23 on a first side of the body 22, and a second support member 24 on a second side of the body 22. In another non-limiting example, the body 22 includes a first crossmember 25 on a first end of the body 22, and a second crossmember 26 on a second end of the body 22. Although the inclusion of the first crossmember 25 and the second crossmember 26 may provide increased support and an improved weight-lifting capacity for the gantry assembly 1, while reducing the weight of the gantry assembly 1, it should be understood that the body 22 may include a single crossmember without departing from the scope of the present disclosure.

The support members 23, 24 may be coupled to the crossmembers 25, 26. It is contemplated, however, that the support members 23, 24 may be integrally formed with the crossmembers 25, 26, without departing from the scope of the present disclosure.

In embodiments, the frame 21 includes a base assembly 27 (or base, for purposes of the present disclosure). The base assembly 27 includes one or more legs 28. Where there are multiple legs 28, the legs 28 may be substantially parallel, and dimensioned to fit within a standard single doorway (i.e., ranging between 30 inches and 48 inches, or between 76 centimeters and 122 centimeters). However, it is contemplated that the legs 28 may be angled to assist in reducing possible interaction between the gantry and the surrounding environment in which the gantry system is being operated. It is noted the base may additionally or alternatively include bumpers to protect door jambs or other openings with walls, and/or furniture or fixtures, within the surrounding environment during movement of the gantry system. It is contemplated that the legs 28 may be round or a central stand, without departing from the scope of the present disclosure.

The one or more legs 28 may each include one or more wheels 29, for use when moving the gantry system 100 (i.e., via the handles 4, as generally illustrated in one or more of FIGS. 1-10). For example, the wheels 29 may include an axle that allows for monoaxial motion along a first axis (e.g., forward/backwards). By way of another example, the wheels 29 may include a caster body (i.e., is a caster wheel) that allows for polyaxial motion along multiple axes (e.g., forwards/backwards, left/right, and any angle therebetween).

It is contemplated the wheels 29 may include locks to prevent rotation, and/or may include dampening hardware to reduce vibration from the winch assembly 2. In addition, it is contemplated the wheels 29 may include vibration dampeners for use when traversing a non-smooth terrain (i.e., when used in a non-paved environment), such as where the gantry system is sized for use with animals in a barnyard and/or on a farm or ranch.

Although embodiments illustrate wheels 29, it is contemplated the gantry assembly 1 may be on a rail or conveyor assembly, that allows the gantry assembly 1 to actuate from between positions along a pre-defined track, without departing from the scope of the present disclosure.

In embodiments, the leg assembly 27 (or, more specifically, the legs 28) are coupled to the body 22. For example, the legs 28 may be coupled to respective support members 23, 24 of the body 22 via one or more gussets 30 and/or plates 31. The use of gussets 30 and/or plates 31 increases the structural stability of the frame 21, by reducing the possibility that the body 22 moves relative to the leg assembly 27.

It is contemplated, however, that the legs 28 may be integrally formed with the support members 23, 24 of the body 22, such that the gussets 30 and/or the plates 31 are not necessarily, without departing from the scope of the present disclosure. In addition, it is contemplated that the legs 28 may be rotatable relative to and/or collapsible against the body 22, such as for increased ease of storage and/or transportation, without departing from the scope of the present disclosure.

In embodiments, the inclusion of the crossmembers 25, 26 allows for the positioning of portions of the winch assembly 2 in a cavity defined between the crossmembers 25, 26. In particular, the gantry assembly 1 includes a winch mount 32 positioned on (or between) one or more bars 33 above the cavity defined between the crossmembers 25, 26. Portions of the winch assembly 2 can thus be inserted between the crossmembers 25, 26 to couple to the winch mount 32, which provides a more stable mounting position for the winch assembly 2 that is less prone to vibration and shaking that may be transferred to the gantry assembly 1 and to the animal being supported.

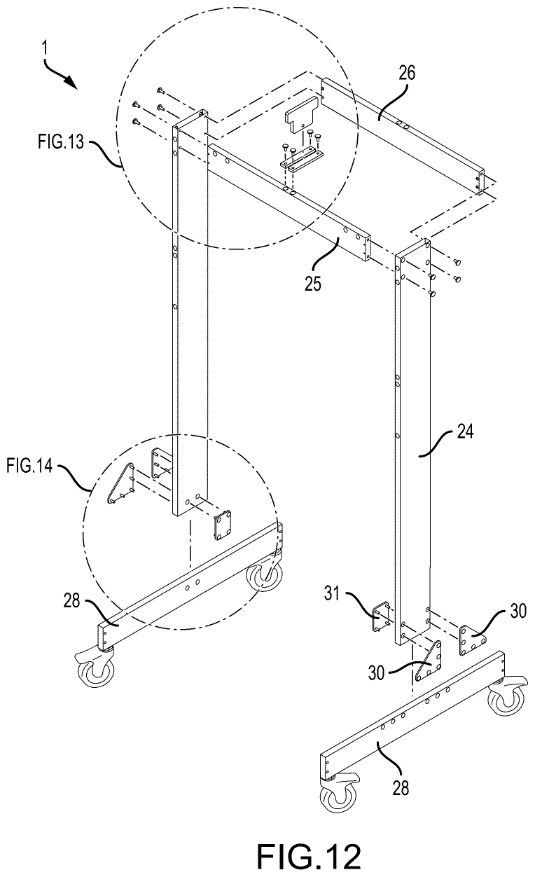

Referring now to FIG. 12, the gantry assembly 1 is illustrated an in exploded perspective view. Detailed areas of the gantry assembly 1, as illustrated with dot-dash lined circles in FIG. 12, are described in detail further herein.

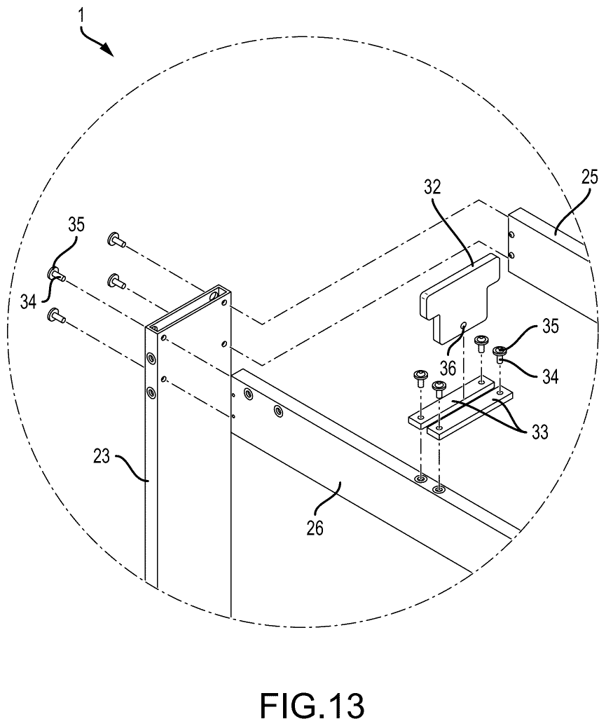

Referring now to FIG. 13, a detailed area illustrates portions of the support member 23 (or support member 24) and the crossmembers 25, 26. The support member 23 is configured to receive fasteners 34, 35 (i.e., within apertures or grooves in the support member 23), where the fasteners 34, 35 secure the support member 23 to the crossmembers 25, 26. For example, the fasteners 35 may include a washer and the fasteners 34 may include a bolt, screw, or other component that threads (or otherwise interlocks) with a corresponding feature on (or proximate to) the crossmembers 25, 26. For instance, the crossmembers 25, 26 may include a corresponding aperture that is threaded, and/or an aperture that leads to a nut (i.e., either positionable proximate to, or affixed to, the crossmembers 25, 26). In general, the support member 23 may include a first component of an interlocking assembly that engages a second component of the interlocking assembly on (or in) the crossmembers 25, 26. It is contemplated that the interlocking assembly may be quick-release or configured like a tab-and-groove assembly, to allow for increased ease of installation and removal of the support member 23 from the crossmembers 25, 26 (i.e., during assembly and/or disassembly of the gantry assembly 1).

Although not shown, it should be understood that support member 24 may be configured to separately secure to the crossmembers 25, 26 in a similar manner as described above with respect to support member 23. However, in some embodiments, such as where the fasteners 34 extend through the support member 23 and the crossmembers 25, 26, it is contemplated that the support member 24 may also receive the fasteners 34 (i.e., prior to the installation of a nut on the end of the fasteners 34).

The bars 33 are configured to receive fasteners 34, 35 (i.e., within apertures or grooves in the support member 23), where the fasteners 34, 35 secure the bars 33 to the crossmembers 25, 26 and the winch mount 32 is positioned between the bars 33. For example, the fasteners 35 may include a washer and the fasteners 34 may include a bolt, screw, or other component that threads (or otherwise interlocks) with a corresponding feature on (or proximate to) the crossmembers 25, 26. For instance, the crossmembers 25, 26 may include a corresponding aperture that is threaded, and/or an aperture that leads to a nut (i.e., either positionable proximate to, or affixed to, the crossmembers 25, 26). In general, the bars 33 may include a first component of an interlocking assembly that engages a second component of the interlocking assembly on (or in) the crossmembers 25, 26. It is contemplated that the interlocking assembly may be quick-release or configured like a tab-and-groove assembly, to allow for increased ease of installation and removal of the bars 33 from the crossmembers 25, 26 (i.e., during assembly and/or disassembly of the gantry assembly 1).

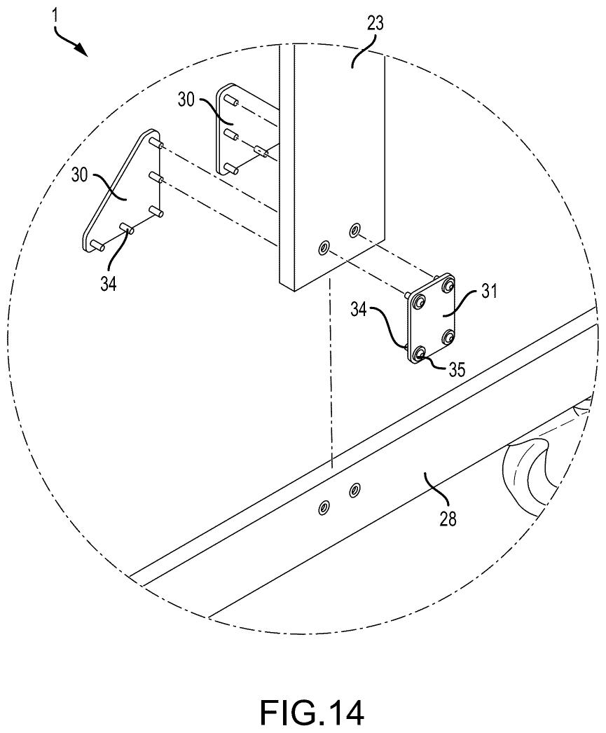

As illustrated in FIG. 13, the winch mount 32 includes a winch aperture 36. The winch aperture 36 is configured to couple to the winch assembly 2, as described in detail further herein. Referring now to FIG. 14, a detailed area illustrates the gussets 30 and the plate 31 that secure the support member 23 to the leg 28. The gussets 30 and the plate 31 is configured to receive fasteners 34, 35 (i.e., within apertures or grooves in the support member 23 and/or the leg 28), where the fasteners 34, 35 secure the gussets 30 and the plate 31 to the support member 23 and/or the leg 28. For example, the fasteners 35 may include a washer and the fasteners 34 may include a bolt, screw, or other component that threads (or otherwise interlocks) with a corresponding feature on (or proximate to) the support member 23 and/or the leg 28. For instance, the support member 23 and/or the leg 28 may include a corresponding aperture that is threaded, and/or an aperture that leads to a nut (i.e., either positionable proximate to, or affixed to, the support member 23 and/or the leg 28). In general, the gussets 30 and the plate 31 may include a first component of an interlocking assembly that engages a second component of the interlocking assembly on (or in) the support member 23 and/or the leg 28. It is contemplated that the interlocking assembly may be quick-release or configured like a tab-and-groove assembly, to allow for increased ease of installation and removal of the gussets 30 and the plate 31 from the support member 23 and/or the leg 28 (i.e., during assembly and/or disassembly of the gantry assembly 1).

Although not shown, it should be understood that the gussets 30 and the plate 31 may be configured to separately secure to the support member 24 and/or a different leg 28 in a similar manner as described above with respect to support member 23 and/or the leg 28. However, in some embodiments, such as where the fasteners 34 extend through the gussets 30 and the plate 31 and support member 23 and/or the leg 28, it is contemplated that the support member 24 and/or the different leg 28 may also receive the fasteners 34 (i.e., prior to the installation of a nut on the end of the fasteners 34).

FIG. 15 illustrates the winch assembly 2, in accordance with one or more embodiments of the present disclosure. It should be understood that embodiments directed to the winch assembly 2 as illustrated in FIGS. 1-10 are directed to the embodiments of the winch assembly 2 as illustrated in FIG. 15, and vice versa, without departing from the scope of the present disclosure.

In embodiments, the winch assembly 2 includes a winch bracket 37 and an actuator 38 installed within the winch bracket 37. The winch bracket 37 includes an insulator 39. For example, the insulator 39 may protect a cable driven by the actuator 38, reducing the wear of the cable against the winch bracket 37.

The winch bracket 37 is couplable to the winch aperture 36 (i.e., as illustrated in FIG. 13) via fasteners 40, 41. In one non-limiting example, the fasteners 40, 41 include a pin and cotter. It is contemplated that use of the pin and cotter allows for increased ease of removal of the winch assembly 2 from the gantry assembly 1 (i.e., during assembly and/or disassembly, such as for repair or replacement). In another non-limiting example, the fasteners 40, 41 include some combination of bolts, washers, and nuts that are threadably engaged.

In some embodiments, the winch assembly 2 includes a cleat mount 42 and a cleat 43. The cleat 43 is operable to receive the cable from the winch bracket 37, wherein the cable is passed at least partially through said cleat 43 and cleat mount 42 to a lifting member 49 and/or a lifting harness 51. The cleat 43 is additionally operable as a safety device, including one or more components that are engageable against the cable to slow the cable or prevent the cable from being raised or lowered by the actuator 38. For example, it is contemplated that the cleat 43 may include a polymeric pad (such as one with a high coefficient of friction) and may include at least one handle 44 that an operator may pull, slide, rotate, or otherwise engage, to cause the pad of cleat 43 to slow, stop, and/or secure the cable by pinning it against an interior surface of the cleat 43 and/or cleat mount 42, a complementary pad present on the opposite side of the cable, or another functionally equivalent braking structure as known in the art. The cleat 43 and cleat mount 42 may also include a biased braking element, such that the handle includes a biasing element (e.g., a spring/spring-load or flexed bar) that provides bias at least towards braking, closure, or stopping wherein a user may engage the cleat 43 with less force in order to quickly and safely slow, halt, or otherwise stop the cable while the biased element maintains that engagement. Furthermore, the present disclosure may also include a secondary biased element to guarantee that the braking element of the cleat 43 and/or cleat mount 42 is not engaged accidentally, for instance it may be biased toward a not-engaged position then become either neutral or biased towards an engaged position beyond a certain angle or threshold. Alternatively, the braking element may include a ball detent mechanism whereby a spring-loaded ball and complementary detent is included within the clear 43 and cleat mount 42 and used to keep the braking element in placed until enough force is applied to overcome the mechanism. It is understood that additional alternative functionally equivalent structures may exist in the art and may be used in lieu of, or in addition to, those described herein.

The cleat 43 is configured to receive fasteners 45 (i.e., within apertures or grooves in the cleat 43), where the fasteners 45 secure the cleat 43 to the cleat mount 42. For example, the fasteners 45 may include an (optional) washer and bolt, screw, or other component that threads (or otherwise interlocks) with a corresponding feature on (or proximate to) the cleat mount 42. For instance, the cleat mount 42 may include a corresponding aperture that is threaded, and/or an aperture that leads to a nut (i.e., either positionable proximate to, or affixed to, the cleat mount 42). In general, the cleat 43 may include a first component of an interlocking assembly that engages a second component of the interlocking assembly on (or in) the cleat mount 42. It is contemplated that the interlocking assembly may be quick-release or configured like a tab-and-groove assembly, to allow for increased ease of removal of the cleat 43 from the cleat mount 42.

FIG. 16 illustrates a lifting member 49 and a lifting harness 51 for use with the gantry system 100, in accordance with one or more embodiments of the present disclosure.

A cable 48 (i.e., coupled to the winch assembly 2, as illustrated in FIG. 15) is couplable to a lifting member 49. For example, the cable 48 is directly coupled to the lifting member 49. By way of another example, the cable 48 is coupled to a quick-release clip 50, which is coupled to the lifting member 49. It is contemplated that the quick-release clip 50 allows for the increased ease and speed of removal of the animal from the gantry system 100.

The lifting member 49 is couplable to a lifting harness 51, to be worn by an animal. The lifting member 49 may have one or more points of contact with the lifting harness 51. The lifting member 49 may be directly coupled to the lifting harness 51, or alternatively be coupled to the lifting harness 51 via a quick-release clip 50 (not shown). It is contemplated that the lifting harness 51 may remain worn by the animal, or may be a component of the gantry system 100 that the animal must be inserted into, without departing from the scope of the present disclosure. In this way, it may be possible to dress the animal in a lifting harness 51 then quickly clip it in or out of the gantry assembly 1 as needed. Additionally, it is further contemplated that the lifting member 49 may more evenly distribute the weight from the lifting harness 51 such that the likelihood of an animal being stressed or injured during the process is minimized.

Although not illustrated, it is contemplated additional securing lines or straps may couple the lifting member 49 and/or the lifting harness 51 to the gantry assembly 1. The additional lines may prevent rotation and/or better stabilize the animal in the cavity defined by the gantry assembly 1, including during raising and/or lowering of the animal.

In general, the gantry system 100 is dimensioned to fit through a standard single-wide doorway, between 60 centimeters and 130 centimeters in width. It should be understood that any dimensions included in FIGS. 1-16 are exemplary, and are not intended to be limiting on the present disclosure.

A number of embodiments of the disclosure have been described. Nevertheless, it will be understood that various modifications may be made without departing from the spirit and scope of the present disclosure. Accordingly, other embodiments are within the scope of the following claims.

What is claimed is:

1. A gantry system for an animal, comprising:
a frame assembly comprising a first support member and second support member defining a space for an animal therebetween, the first support member and the second support member comprising substantially vertical members comprising an upper end and a lower end and a length extending therebetween, wherein at least one of the first support member and the second support member comprises a channel operable to receive at least one additional component of the system;
a basal member provided proximal to the lower end of each support member;
a crossmember provided proximal to the upper end of each support member;
a handle in communication with at least a portion of the frame assembly;
a plurality of wheels coupled to the basal member;
an on-board power supply;
a control system;
a winch assembly comprising an actuator in communication with the on-board power supply and a cable retractably extendable from the winch assembly operable to support at least a portion of a weight of an animal provided within the space;
a quick release clip removably securable to the cable; and
a lifting member.

2. The system of claim 1, wherein the at least one additional component of the system comprises at least one of a cable, wire, cord, link, or line connecting at least two elements defined herein.

3. The system of claim 1, wherein the plurality of wheels further comprises at least one wheel vibration dampener.

4. The system of claim 1, wherein the panel further comprises at least one retainment element, such as a magnetic portion, shelves, folders, cubbies, or at least one equivalent structure.

5. The system of claim 1, wherein the crossmember further comprises a removably fastenable vibration dampener proximal to the winch assembly.

6. The system of claim 1, wherein the actuator further comprises a removably securable actuator switch that is in direct, wired communication or indirect, wireless communication with the winch assembly and is capable of altering the location of and support provided by the retractably extendable cable.

7. The system of claim 1, wherein the on-board power supply further comprises a battery assembly comprising a rechargeable battery having a battery port and a battery bracket.

8. The system of claim 1, wherein the control system further comprises a user interface coupled with at least one control unit including at least one of a transmitter or receiver.

9. The system of claim 1, wherein the gantry system's components are at least partially waterproof, via shieldings, coatings, or an equivalent feature, such that the system can be utilized in water therapy or for aquatic animals.

10. The system of claim 1, wherein the control system further comprises at least one sensor capable of completing at least one of the recognition, determination, and reporting of various operational, physical, or environmental parameters proximal to the system.

11. A gantry system for an animal, comprising:
a frame assembly comprising a first support member and second support member defining a space for an animal therebetween, the first support member and the second support member comprising substantially vertical members comprising an upper end and a lower end and a length extending therebetween, wherein at least one of the first support member and the second support member comprises a channel operable to receive at least one additional component of the system;
at least one basal member provided proximal to the lower end of each support member;
a crossmember provided proximal to the upper end of each support member;
a panel removably securable to at least one side of the frame assembly, configured to retain medical devices, documents, or other items common to the medical profession;
a handle in communication with at least one of a portion of the frame assembly and the panel;
a plurality of lockable wheels coupled to the at least one basal member, wherein each wheel is movable in either a mono-axial or poly-axial direction; and
a winch assembly comprising an actuator in communication with the on-board power supply and a cable retractably extendable from the winch assembly operable to support at least a portion of a weight of an animal provided within the space;
a quick release clip removably securable to the cable; and
a cleat mount and a cleat operable to receive the cable from the winch bracket wherein the cleat is operable as a safety device to slow or halt the cable's motion; and
a lifting member disposed distal to the crossmember and removably couplable to at least one of the cable and the quick release clip.

12. The system of claim 11, wherein the at least one component of the system comprises at least one of a cable, wire, cord, link, or line connecting at least two elements defined herein.

13. The system of claim 11, wherein the actuator is a manual mechanical device such that the winch is capable of lifting, supporting, or unweighting at least a portion of an animal once physically worked upon by a user.

14. The system of claim 11, further comprising an on-board power supply and control system, wherein the actuator is an electric mechanical device such that the winch is capable of lifting, supporting, or unweighting at least a portion of an animal upon a user's application of power and control.

15. The system of claim 14, wherein the on-board power supply further comprises a battery assembly comprising a rechargeable battery having a battery port and a battery bracket.

16. The system of claim 11, wherein the panel further comprises at least one retainment element, such as a magnetic portion, a shelf, a folder, a cubby, or at least one equivalent structure.

17. The system of claim 11, wherein the plurality of lockable wheels further comprises at least one wheel vibration dampener.

18. The system of claim 11, wherein the gantry system's components are at least partially waterproof, via shieldings, coatings, or equivalent features, such that the system can be utilized in water therapy and for aquatic animals.

19. A gantry system for an animal, comprising:
a frame assembly comprising at least a first and second support member defining a space for an animal therebetween, wherein each support member is substantially vertical, comprises an upper end and a lower end and a length extending therebetween, wherein at least one support member comprises a channel operable to receive at least one component of the system, such as a cable, wire, cord, link, or line, or an equivalent element connecting at least two elements defined herein;
at least one basal member provided proximal to the lower end of each support member;
a crossmember provided proximal to the upper ends of each support member;
a panel removably securable to at least one side of the frame assembly, configured to retain medical devices, documents, or other items common to the medical profession comprising at least one retainment element, such as a magnetic portion, a shelf, a folder, a cubby, or at least one equivalent structure;
a handle in communication with at least one of a portion of the frame assembly and the panel;
a plurality of lockable wheels coupled to the at least one basal member, wherein each wheel is movable in either a mono-axial or poly-axial direction;
an on-board power supply comprising a battery assembly having at least a rechargeable battery, a battery port, and a battery bracket;
a control system comprising at least one of a user interface coupled with at least one of a control unit and a control panel;
a winch assembly, comprising an actuator in communication with the on-board power supply and a cable retractably extendable from the winch assembly operable to support or unweight at least a portion of a weight of an animal provided within the space;
a cleat mount and a cleat operable to receive the cable wherein the cleat is operable as a safety device to slow or halt the cable's motion;
a quick release clip removably securable to the cable; and
a lifting member disposed distal to the crossmember and removably couplable to at least one of the cable and the quick release clip.

20. The system of claim 19, wherein the gantry system's components are at least partially waterproof, via shieldings, coatings, or at least one equivalent feature, such that the system can be utilized in water therapy and for aquatic animals.
